(19) United States
(12) Patent Application Publication
(10) Pub. No.: US 2014/0279762 A1
(43) Pub. Date: Sep. 18, 2014

(54) ANALYTICAL NEURAL NETWORK INTELLIGENT INTERFACE MACHINE LEARNING METHOD AND SYSTEM

(71) Applicant: REMTCS Inc., Red Bank, NJ (US)

(72) Inventors: Tommy Xaypanya, Lamar, MS (US); Richard E. Malinowski, Colts Neck, NJ (US)

(73) Assignee: REMTCS Inc., Red Bank, NJ (US)

(21) Appl. No.: 14/216,665

(22) Filed: Mar. 17, 2014

Related U.S. Application Data
(60) Provisional application No. 61/794,430, filed on Mar. 15, 2013.
(60) Provisional application No. 61/794,472, filed on Mar. 15, 2013.
(60) Provisional application No. 61/794,505, filed on Mar. 15, 2013.
(60) Provisional application No. 61/794,547, filed on Mar. 15, 2013.
(60) Provisional application No. 61/891,598, filed on Oct. 16, 2013.
(60) Provisional application No. 61/897,745, filed on Oct. 30, 2013.
(60) Provisional application No. 61/901,269, filed on Nov. 7, 2013.

(51) Int. Cl. G06N 3/08

(52) U.S. Cl. CPC G06N 3/08
USPC 706/12

(57) ABSTRACT

A learning framework and methods of machine learning are disclosed. Specifically, an Analytical Neural Network Intelligent Interface (ANNII) is disclosed that includes the ability to analyze incoming data in substantially real-time and determine whether or not the data is statistically anomalous data. Learning models can then be updated depending upon whether or not the data is determined to be statistically anomalous data or not.

### CROSS-REFERENCE TO RELATED APPLICATIONS

The present application claims the benefit of U.S. Provisional Patent Application Nos. 61/794,430, 61/794,472, 61/794,505, 61/794,547, 61/891,598, 61/897,745, and 61/901,269, filed on Mar. 15, 2013, Mar. 15, 2013, Mar. 15, 2013, Mar. 15, 2013, Oct. 16, 2013, Oct. 30, 2013, and Nov. 7, 2013, respectively, each of which are hereby incorporated herein by reference in their entirety.

### FIELD OF THE DISCLOSURE

The present disclosure is generally directed machine learning and, in particular, an analytical neural network intelligent interface.

### BACKGROUND

Machine learning, a branch of artificial intelligence, is about the construction and study of systems that can learn from data. For example, a machine learning system could be trained on email messages to learn to distinguish between spam and non-spam messages. After learning, it can then be used to classify new email messages into spam and non-spam folders.

The core of machine learning deals with representation and generalization. Representation of data instances and functions evaluated on these instances are part of all machine learning systems. Generalization is the property that the system will perform well on unseen data instances; the conditions under which this can be guaranteed are a key object of study in the subfield of computational learning theory.

### SUMMARY

It is one aspect of the present disclosure to provide an improved machine learning framework. Specifically, embodiments of the present disclosure leverage biotechnology and financial services quantitative algorithms and statistical analysis models to improve Artificial Intelligence (AI) learning techniques. Specifically, the biotechnology and financial quantitative algorithms and statistical models can be used to create a decision tree analysis to solve structured and unstructured data problems through the automated creation of decision trees. In some embodiments, this may include the ability to use multiple detection and analytical algorithms with ultra low latency, as well as micro burst technology, thereby enabling data traffic to be compressed in pushed in real-time speeds through sensors to an correlation/analysis engine.

In some embodiments, an apriori algorithm is employed to mine association rules via our own trending engine topology to update definitions of behavioral and/or activity (e.g., statistically anomalous events) both from a structured as well as unstructured perspective. An example of such an algorithm is provided below where the following is considered:
DS: database of structured transactions;
DUS: database of unstructured transactions:
T ε DS/DU: a transaction for T⊂ I;
TID: unique identifier, associated with each T;
X: a subset of I
Tree (T) contains X if X ⊂ T Associationrule: X [symbol] YhereX⊂I,Y⊂IandX∩Y=ØSupp(X ∪ Y)=number of transactions in DS+DU contain (X ∪ Y)
In the above, ANNI can be utilized as a combinaturic engine to understand and derive the correlations and form a decision tree automatically after analyzing the structured and unstructured data components. ANNI will create its own rule sets from these data combinations.

In some embodiments, the above-noted algorithm or a variant thereof can be utilized in connection with clustering to provide detection and prediction techniques. A non-limiting example of such a detection learning method is provided below:

In some embodiments, a behavioral detection/learning framework is provided that leverages at least some of the algorithmic examples described herein. Frameworks of identifiable and unidentified data/signatures may comprise and be clustered from industry and/or real-time observations of the system. Newly-received data (e.g., new IP packets, new files, new programming code, etc.) can be passed through a decision tree and clustered of fuzzy neural network algorithms and then, depending upon the results of such analysis, may be positioned towards the appropriate categorizations/fields..

One example of an appropriate data identification is a Virtual Machine environment, which can provide a sandbox for further analysis of the code. In some embodiments, unknown or uncertain packets (e.g., code portions) can be sent to a machine learning High Performance Computing (HPC) blade. The HPC blade may operate, in accordance with embodiments, an artificial intelligence engine that runs the potential malware using stacked, cross-platform technologies coupled with in-house developed machine level code. In some embodiments, the code is executed in a safe virtual (hypervisor) sandbox (e.g., in an isolated environment) collecting information about the APIs called by the program. Then hash dumps, along with signatures of the code can be sent back to the learning framework to proceed with countermeasures decisions and further development of models based on the same.

In some embodiments the code may be deconstructed using a data decomposition technique similar to DNA sequencing.

In some embodiments, an Analytical Neural Network Intelligent Interface (ANNII) Machine Learning method and system are provided. Machine learning methods can provide a way for Encog (e.g., a neural network and artificial intelligence framework available for Java, .Net, and Silverlight) to implement machine learning. Encog supports the following machine learning methods. Encog uses machine learning methods to implement forms of Regression, Classification, Clustering, Optimization, and Auto-association. At least some of the following models or methods may be employed by the learning framework: we use our own set of combinaturic learning by employing quantitative models from various fields of study through the use of the following classification algorithms thereby greatly accelerating ANNI's ability to learn:
Regression Analysis—this process can be utilized by taking in several inputs to produce one or more outputs thus creating an automated decision tree model. It may then be possibly to identify which of a set of categorical data (or sub-populations in order to build a data frameset) to where a new observation belongs, on the basis of a training set of data containing observations so we can identify the category membership or association mostly through multiple regressions and Combinaturics. The algorithm works, in some embodiments, in terms of identifying discrete data elements (e.g., parameters, parametric values, by locking certain explanatory and non-dependent variables, and iteratively regressing the data, as well as with unassociated variables, etc.) but also the combination of elements to form a higher level data set to determine the proper categorization. Real time data can then be utilized by requiring that real-valued or integer-valued data to be discretized into group associations which are then mapped to a discrete category. Once this is accomplished, all new unstructured data can be taken and clustered to associated groupings (instances of explanatory variables and dependent variables—for this we calculate the nearest distance between the associations/variables—utilizing a quantitative spread spectrum analysis for clustering). In some embodiments, a vectoring model can be used since the data is multi-variable to optimize the data (e.g., since it's not flat) to assist in the auto association of the categories.
Data Decomposition—Embodiments of the present disclosure utilize a purpose-built model to decompose the data inputs into its elemental components (e.g., variables, parameters, etc.) to create a relevance modeling capabilities.
Numerical Taxonomy (from quantitative mathematics—Groups can be defined based on shared characteristics and categories can be created for each group or associations. Each group is then ranked and groups of a given rank can be aggregated to form a larger category group for hierarchical classification (sort of a super group which may have multiple associations). With multiple associations we can then run multiple iterations of regression analysis to prove to the decision tree ANNI has derived from the data.
Cluster Analysis/Correlation Engine: Supports vector modeling and is a supervised learning model(s) with associated learning algorithms that analyze data and recognize DNA type pattern analysis, used for classification and the above stated regression analysis. The basic Support Vector Modeling takes a set of input data and predicts, for each given input, which possible classifies the forms of the output, making it a non-probabilistic binary linear classifier—again proven to categorization. Given a set of training examples, each marked as belonging to one of two categories, a training algorithm builds a model that assigns new examples into one category or the other and will also detect anomalies within the data ranges. Our model then forms a representation of the examples as points in space, mapped so that the examples of the separate categories are divided by a clear gap that is as wide as possible to set the categories. New examples are then mapped into that same space and predicted to belong to a category based on how close each datapoint or which side of the gap they fall on—above or below the median (non-variable). In addition to performing linear classification, non-linear classification can also be performed using what is called the kernel trick-shallow fast learning algorithms, implicitly mapping their inputs into high-dimensional feature spaces. Since ANNII can be built into an HPC, it becomes possible to detect non structured data correlations and to acknowledge probabilities of patterns over large amounts of data quickly (e.g., 120 ns to 10 microseconds).
A Bayesian network—Generalization model or probabilistic directed acyclic (we use the term as indicators) graphical model is a probabilistic graphical model (a type of statistical model) that represents a set of random variables and their conditional dependencies via a directed acyclic graph (DAG). For example, a Bayesian network could represent the probabilistic relationships between inputs and outcomes (a decision tree). Given the outcomes, the network can be used to compute the probabilities of the presence of various indicators with respect to their relevance to the topic being researched. Formally, Bayesian networks are directed acyclic graphs whose nodes represent random variables in the Bayesian sense: they may be observable quantities, latent variables, unknown parameters or hypotheses. Edges represent conditional dependencies; nodes which are not connected represent variables which are conditionally independent of each other. Each node is associated with a probability function that takes as input a particular set of values for the node's parent variables and gives the probability of the variable represented by the node. For example, if the parents are Boolean variables then the probability function could be represented by a table of entries, one entry for each of the possible combinations (Combinaturic sequencing of its parents being true or false. Similar ideas may be applied to undirected, and possibly cyclic datapoints. Rescaled range analysis was developed to spot trends hidden in the seeming randomness of African rainfall and its effect on Nile river flooding—but its application to neural network learning reveals many interesting insights in locating anomalous behaviors.
Markov networks—In the domain of physics and probability, a Markov random field (often abbreviated as MRF), Markov network or undirected graphical model is a set of random variables having a Markov property described by an undirected graph. A Markov random field is similar to a Bayesian network in its representation of dependencies; the differences being that Bayesian networks are directed and acyclic, whereas Markov networks are undirected and may be cyclic/hence unstructured. Thus, a Markov network can represent certain dependencies that a Bayesian network cannot (such as cyclic dependencies); on the other hand, it can't represent certain dependencies that a Bayesian network can (such as induced dependencies—locking variables). The Markov principles can be used in conjunction with several combinations of algorithms to increase the relevance of the data to identify new categorizations for the unstructured data. The data can then be tested through regression analysis by locking individual variables and running iterations to test arious theories. This has proven to be successful in 4 separate applications utilizing ANNI's ability to create decision trees.
Relevance—Relevance diagramming can be utilized and a decision tree diagram or graphical and mathematical representation of a decision situation can be presented. It is a generalization of a Bayesian network, in which not only probabilistic inference problems but also decision making problems (following maximum expected utility criterion tested through regression analysis) can be modeled and solved. This can be programmed statistically into ANNI's inputs to create a decision tree of probabilistic outputs.
Influence diagrams—Generalizations of categories and networks that can represent and solve decision problems under uncertainty.
Heuristic Modeling/Simulated Annealing/Risk Modeling—Is a generic probabilistic meta-heuristic for the global optimization problem of locating a good approximation to the global optimum of a given function in a large search space—taking unstructured data and forming a approximated association. It is often used when the search criteria is discrete/finite. For certain problems, simulated annealing may be more efficient (e.g., a lot faster) than the exhaustive enumeration such as regression analysis—provided that the goal is merely to find an acceptably good solution in a fixed amount of time, rather than all possible solutions to a problem which may take excessive time in relation to a severe time dependant problem or issue. It should be noted that many commonly used mathematical terms have originated from this form of algorithm. This type of algorithm we view as risk modeling.
Monte Carlo Simulators—Accepting approximated solutions is a fundamental proposition of heuristic modeling because it allows for a faster extensive search for the optimal solution by injecting a set of approximated variables which can then be raised or lowered quickly to plot a direction. We have found direct usages by taking Biotechnology and Financial services models and utilizing them for AI learning.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Also, while the disclosure is described in terms of exemplary embodiments, it should be appreciated that individual aspects of the disclosure can be separately claimed. The present disclosure will be further understood from the drawings and the following detailed description. Although this description sets forth specific details, it is understood that certain embodiments of the disclosure may be practiced without these specific details. It is also understood that in some instances, well-known circuits, components and techniques have not been shown in detail in order to avoid obscuring the understanding of the invention

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The present disclosure is described in conjunction with the appended figures:

FIG. 1 is a block diagram depicting a computing system in accordance with embodiments of the present disclosure;

FIG. 2 is a diagram depicting a learning framework in accordance with embodiments of the present disclosure; and

FIG. 3 is a flow chart depicting a machine-learning method in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

Referring initially to FIG. 1, a system 100 is depicted as including one or more computational components that can be used in conjunction with an AI system. More specifically, the intelligent computing system 100 is depicted as including a communication network 104 that connects a computing device 108 to one or more data sources 128 and one or more consumer devices 132.

In accordance with at least some embodiments, the computing device 108 may comprise a processor 116 and memory 112. The processor 116 may be configured to execute instructions stored in memory 112. Illustrative examples of instructions that may be stored in memory 112 and, therefore, be executed by processor 116 include ANNI 120 and a communication module 124.

The communication network 104 may correspond to any network or collection of networks (e.g., computing networks, communication networks, etc.) configured to enable communications via packets (e.g., an Internet Protocol (IP) network). In some embodiments, the communication network 104 includes one or more of a Local Area Network (LAN), a Personal Area Network (PAN), a Wide Area Network (WAN), Storage Area Network (SAN), backbone network, Enterprise Private Network, Virtual Network, Virtual Private Network (VPN), an overlay network, a Voice over IP (VoIP) network, combinations thereof, or the like.

The computing device 108 may correspond to a server, a collection of servers, a collection of mobile computing devices, personal computers, smart phones, blades in a server, etc. The computing device is connected to a communication network 104 and, therefore, may also be considered a networked computing device. The computing device 108 may comprise a network interface or multiple network interfaces that enable the computing device 108 to communicate across various types of communication networks. For instance, the computing device 108 may include a Network Interface Card, an antenna, an antenna driver, an Ethernet port, or the like. Other examples of computing devices 108 include, without limitation, laptops, tablets, cellular phones, Personal Digital Assistants (PDAs), thin clients, super computers, servers, proxy servers, communication switches, Set Top Boxes (STBs), smart TVs, etc.

As noted above, other embodiments of the computing device 108 may correspond to a server or the like. When implemented as a server, the computing device 108 may correspond to a physical computer (e.g., a computer hardware system) dedicated to run or execute one or more services as a host. In other words, the server may serve the needs of users of other computers or computing devices connected to the communication network 104. Depending on the computing service that it offers, the server implementation of the computing device 108 could be a database server, file server, mail server, print server, web server, gaming server, or some other kind of server.

The memory 112 may correspond to any type of non-transitory computer-readable medium. Suitable examples of memory 112 include both volatile and non-volatile storage media. Even more specific examples of memory 112 include, without limitation, Random Access Memory (RAM), Dynamic RAM (DRAM), Static RAM (SRAM), Flash memory, Read-Only Memory (ROM), Programmable ROM (PROM), Erasable PROM (EPROM), Electronically Erasable PROM (EEPROM), virtual memory, variants thereof, extensions thereto, combinations thereof, and the like. In other words, any type of electronic data storage medium or combination of storage media may be used without departing from the scope of the present disclosure.

The processor 116 may correspond to a general purpose programmable processor or controller for executing programming or instructions stored in memory 112. In some embodiments, the processor 116 may include one or multiple processor cores and/or virtual processors. In other embodiments, the processor 116 may comprise a plurality of separate physical processors configured for parallel or serial processing. In still other embodiments, the processor 116 may comprise a specially configured Application Specific Integrated Circuit (ASIC) or other integrated circuit, a digital signal processor, a controller, a hardwired electronic or logic circuit, a programmable logic device or gate array, a special purpose computer, or the like. While the processor 116 may be configured to run programming code contained within memory 112, such as ANNI 120, the processor 116 may also be configured to execute other functions of the computing device 108 such as an operating system, one or more applications, communication functions, and the like.

ANNI 120 may comprise the quickly and efficiently learn and apply new learning models to any number of problems or fields of use. In particular, ANNI 120 may comprise a learning framework in which data mining operations are performed to determine conditions and analyze all possible outcomes from those conditions. The learning system and method, as disclosed herein, provides the ability to mine data from virtually any source, develop a decision tree based on predicted, most probable, least probable, etc. outcomes and then utilize the decision tree for analyzing decision options to the problem. It can be appreciated that the use-cases for such a system are virtually limitless. Some non-limiting examples of use cases for an ANNI 120 as disclosed herein include the following:
Macted ANNI—Military ANNI that can be used as a correlation engine to solve immediate military issues: ANNI would be used to create a decision tree to predict future occurrences
ANNI Drone—The ability to review Geospatial changes in topography to see if any changes are occurring. ANNI would be placed in a drone, flying over a geography to see if anyone is digging holes, creating major changes in topography, earth movements and in real time (within 40 microseconds start to relay this information back to HQ).
Blue on Green—ANNI would be used to predict the occurrences of Afgani soldiers attacking US/NATO troops. This system can be used to identify the characteristics of a successful attack.
In Front of the Wire—This implementation of ANNI predicts when an attack will occur on a forward base.
ANNI Health—The ability to receive inputs from bio-sensors (e.g., EKG machines, blood pressure, temperature, etc.) and mine the data from the bio-sensors to develop treatment options (e.g., a decision tree with treatment options based on conditions of the human body) and further determine the best treatment option for the patient based on current and predicted body conditions
ANNI Black—A combinatoric model that picks the most profitable trade to make at any given time based on current market conditions and makes the trade. This implementation of ANNI may specifically provide the ability to switch from one trading algorithm to another trading algorithm as market conditions develop. For instance, the decision tree and the analysis of the current market conditions may dictate that the trading algorithm should switch from a volume trading algorithm to a volatility trading algorithm or a hedge model as market conditions evolve.
ANNI Forensics—An implementation of ANNI for forensics purposes (e.g., network forensics)

In some embodiments, ANNI 120 may be configured to receive and process data from the one or more data sources 128 and then, based on its continuously updated learning models, provide data outputs to one or more consumer devices 132. It should be further appreciated that the data source(s) 128 may be the same as the consumer devices 132, although this is not a requirement.

The communication module 124 may comprise any hardware device or combination of hardware devices that enable the computing device 108 to communicate with other devices via a communication network. In some embodiments, the communication module 124 may comprise a network interface card, a communication port (e.g., an Ethernet port, RS232 port, etc.), one or more antennas for enabling wireless communications, one or more drivers for the components of the interface, and the like. The communication module 124 may also comprise the ability to modulate/demodulate, encrypt/unencrypt, etc. communication packets received at the computing device 108 from a communication network and/or being transmitted by the computing device 108 over the communication network 104. The communication module 124 may enable communications via any number of known or yet to be developed communication protocols. Examples of such protocols that may be supported by the communication module 124 include, without limitation, GSM, CDMA, FDMA, and/or analog cellular telephony transceiver capable of supporting voice, multimedia and/or data transfers over a cellular network. Alternatively or in addition, the communication module 124 may support IP-based communications over a packet-based network, Wi-Fi, BLUETOOTH™, WiMax, infrared, or other wireless communications links.

With reference now to FIG. 2, an illustrative learning framework is depicted in accordance with at least some embodiments of the present disclosure. The learning framework, in some embodiments, enables an artificial intelligence correlation engine 216, which may correspond to an instance of ANNI 120, to operate within an assembler 212 (e.g., a data assembler). One function that may be performed by the correlation engine 216 is to identify statistical anomalies or statistically anomalous events by analyzing various data or event inputs in the correlation engine 216, comparing the data or event inputs with previously-observed or learned events, determining whether the newly-received data or event inputs can be correlated within at least one statistical model to the previously-observed or learned events, and then marking the newly-received data or event as either “normal” or a statistically anomalous event. In some embodiments, the newly-received data or event may be identified as a statistically anomalous event if it cannot be correlated with at least one statistical model that is constructed based on previously-observed or learned events already identified as “normal” or allowable.

Said another way, the correlation engine 216 may be configured to identify statistically anomalous events by comparing newly-received data or event information with a plurality of different statistical models that are build on trusted and previously-observed or learned events. If the newly-received data does not fit within a defined “normal value” as prescribed by a predetermined number of the statistical models, then the newly-received data is marked as a statistically anomalous event and is quarantined for further analysis. On the other hand, if the newly-received data does fit within a defined “normal value”, then the newly-received data can be added to the appropriate models, the models and their definition of “normal” can be updated. The updated models and their definitions are then available for use in analyzing later received data.

In some embodiments, the types of models used for analyzing/comparing newly-received data does not necessarily have to be statistical. Specific, but non-limiting examples of the types of models that may be used for analysis of newly-received data include: regression analysis; cluster analysis/spread spectrum analysis; Bayesian Probability Analysis (Acyclic); Markov Networks; Relevance Analysis; Heuristic Modeling/Meteheuristic; Simulated Annealing; Genetic Algorithms; Statistical Analysis; Support Vectors, Monte Carlo Simulators; combinations thereof; and the like.

As can be appreciated, if newly-received data does not fit within one model as normal, the fact that the data does not fit within a single model may not necessarily cause the newly-received data to be identified as a statistically anomalous event. Instead, embodiments of the present disclosure contemplate the ability to define a statistically anomalous event as any event having data associated therewith that violates a predetermined number of models (e.g., where the predetermined number can be any integer value greater than or equal to one, two, three, four, five, . . . , ten, etc.), a predetermined set of models (e.g., a specific set of analytical models, where each potential set may have different groups of models), a predetermined model by a predetermined amount (e.g., a predetermined percentage away from the defined normal of a model), combinations thereof, or the like.

As shown in FIG. 2, it is also an aspect of the present disclosure to enable the correlation engine 216 to process data or event inputs from a number of different machine languages. Specifically, the correlation engine 216 may operate under a statistical analysis layer (e.g., the layer responsible for analyzing the statistical/heuristic/simulation models to identify statistically anomalous events), which operates under a combinatory/clustering layer. These layers may all operate under a data decomposition layer that operates to decompose data inputs from any machine language into its elemental or basic pieces (e.g., variable identities, variable values, parameter values, header information, routing information, etc.). In some embodiments, the data decomposition layer is responsible for receiving data input from an abstraction layer, which resides above the data decomposition layer, and extracting the elemental pieces of the data inputs. These elemental pieces may eventually correspond to the data that is analyzed at the lower layers of the learning framework.

The learning framework further comprises an interpreter layer 208 above the abstraction layer and an instruction layer above that. The overall construction of the learning framework enables the correlation engine 216 to analyze machine inputs from any number of languages. In other words, the correlation engine 216 is configured to analyze and learn at the byte level. The interpreter 208 and assembler 212 enable the correlation engine 216 to operate within the computing system 204 (which may correspond to an instance of computing device 108). Examples of the languages that may be analyzed by the learning framework include, without limitation, C, C+, C#, Object C, Java, Encog, Fortran, Python, PHP, PERL, Ruby Rails, Open CL, R, K, and any other language known or yet to be developed.

As can be appreciated, the correlation engine 216 may be executed in a High Performance Computing (HPC) environment. Specifically, the correlation engine 216 may be configured to receive and analyze data in near real-time (120 ns backplane), thereby enabling the learning framework to learn almost as quickly as data is received. Not only does this make the learning framework highly efficient, but it also makes it extremely useful in environment requiring quick and accurate decisions.

In some embodiments, any type of code (e.g., C#) along with a machine learning library can be derived from Encog. The framework extension tool described herein can be used with Microsoft visual studio or any development tool. This essentially lets any user program in their own variables for the ANNI framework—providing a virtually limitless mechanism for training and leveraging ANNII. Embodiments of the present disclosure also provide an integration agent layer that allows a user to utilize Matlab to create or modify ANNII algorithms as well test the framework parameters. Embodiments of the present disclosure also enable a graphical representation of ANNII and the framework shown in FIG. 2.

With reference now to FIG. 3, additional details of a learning method will be described in accordance with embodiments of the present disclosure. The method begins when one or more original data inputs are received at the learning framework (step 304). The received data is then decomposed into its elemental pieces (step 308). In some embodiments, one or more variables, variable values, parameter values, header values, or the like are extracted from the received data and constitute elemental pieces of the received data.

The decomposed data or elemental pieces (e.g., the portions data extracted from the original data input) is then provided to the statistical analysis layer (step 312) where the data is compared to one or more statistical, heuristic, and/or simulation models (step 316). Specifically, the data can be compared to one or more models that have been developed based on training of the system during run-time, based on initially input definitions of “normal” models, or combinations thereof. These comparisons are performed to determine if the newly-received data corresponds to statistically anomalous data (step 320).

If the received data violates one or more definitions of “normal” within a predetermined number or set of models, then the data is marked as statistically anomalous (step 324) and may be further quarantined for further analysis by the learning framework (step 328). Specifically, the learning framework may analyze additional parameters or components of the originally-received data to determine one or more signatures or hashes that describe the data and develop and white list, black list, or some other rule set based on this analysis.

Furthermore, one or more of the models may be updated to include the statistically anomalous data (or an anomaly data model may be developed to describe the statistically anomalous data) (step 332). Referring back to step 320, if the data is not identified as statistically anomalous data, then one or more of the models in the analysis layer may be updated to include or add the new data to the model and further update the rule's definition.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
receiving a data input at a computer learning framework;
decomposing the data input into elemental pieces;
providing the elemental pieces of the data input to a statistical analysis layer where the elemental pieces are compared to one or more statistical models to determine if the data input corresponds to a statistically anomalous event; and
at least one of marking the data input as statistically anomalous and updating the one or more statistical models.

2. The method of claim 1, wherein decomposing the data input comprises extracting at least one of a variable, variable value, parameter value, and header value from the data input.

3. The method of claim 1, wherein the data input corresponds to any one of the following machine languages: C, C+, C#, Object C, Java, Encog, Fortran, Python, PHP, PERL, Ruby Rails, and Open CL.

4. The method of claim 1, further comprising:
executing the statistical analysis layer in a High Performance Computing (HPC) environment.

5. The method of claim 1, wherein the one or more statistical models include at least one of the following: regression analysis; cluster analysis/spread spectrum analysis; Bayesian Probability Analysis (Acyclic); Markov Networks; Relevance Analysis; Heuristic Modeling/Meteheuristic; Simulated Annealing; Genetic Algorithms; Statistical Analysis; Support Vectors, Monte Carlo Simulators; and combinations thereof.

6. The method of claim 1, wherein the data input is provided to a virtual machine for further analysis in the event that the data input is identified as statistically anomalous.

7. The method of claim 1, wherein the data input is identified as statistically anomalous according to the following algorithm: if X ⊂ T Associationrule:X [symbol] YhereX⊂I,Y⊂IandX∩Y=ØSupp(X ⊂ Y)=number of transactions in D contain (X ∪ Y), where X is a subset of I; D is a database of transactions; T ε D is a transaction for T ⊂ I; and TID is a unique identifier, associated with each T.

8. A non-transitory computer-readable medium comprising processor-executable instructions that, when executed by a processor, perform a method, the method comprising:
receiving a data input at a computer learning framework;
decomposing the data input into elemental pieces;
providing the elemental pieces of the data input to a statistical analysis layer where the elemental pieces are compared to one or more statistical models to determine if the data input corresponds to a statistically anomalous event; and
at least one of marking the data input as statistically anomalous and updating the one or more statistical models.

9. The computer-readable medium of claim 8, wherein decomposing the data input comprises extracting at least one of a variable, variable value, parameter value, and header value from the data input.

10. The computer-readable medium of claim 8, wherein the data input corresponds to any one of the following machine languages: C, C+, C#, Object C, Java, Encog, Fortran, Python, PHP, PERL, Ruby Rails, and Open CL.

11. The computer-readable medium of claim 8, wherein the method further comprises:
executing the statistical analysis layer in a High Performance Computing (HPC) environment.

12. The computer-readable medium of claim 8, wherein the one or more statistical models include at least one of the following: regression analysis; cluster analysis/spread spectrum analysis; Bayesian Probability Analysis (Acyclic); Markov Networks; Relevance Analysis; Heuristic Modeling/Meteheuristic; Simulated Annealing; Genetic Algorithms; Statistical Analysis; Support Vectors, Monte Carlo Simulators; and combinations thereof.

13. The computer-readable medium of claim 8, wherein the data input is provided to a virtual machine for further analysis in the event that the data input is identified as statistically anomalous.

14. The computer-readable medium of claim 8, wherein the data input is identified as statistically anomalous according to the following algorithm: if X ⊂ T Associationrule:X [symbol] YhereX⊂I,Y⊂IandX∩Y=ØSupp(X ∪ Y)=number of transactions in D contain (X ⊂ Y), where X is a subset of I; D is a database of transactions; T ε D is a transaction for T⊂ I; and TID is a unique identifier, associated with each T.

15. A machine-learning system, comprising:
a microprocessor configured to execute instructions stored in computer memory; and
computer memory including:
a computer learning framework that, when executed by the processor, is configured to receive a data input, decompose the data input into elemental pieces, provide the elemental pieces of the data input to a statistical analysis layer where the elemental pieces are compared to one or more statistical models to determine if the data input corresponds to a statistically anomalous event, and at least one of mark the data input as statistically anomalous and update the one or more statistical models.

16. The machine-learning system of claim 15, wherein decomposing the data input comprises extracting at least one of a variable, variable value, parameter value, and header value from the data input.

17. The machine-learning system of claim 15, wherein the data input corresponds to any one of the following machine languages: C, C+, C#, Object C, Java, Encog, Fortran, Python, PHP, PERL, Ruby Rails, and Open CL.

18. The machine-learning system of claim 15, wherein the computer learning framework is executed in a High Performance Computing (HPC) environment.

19. The machine-learning system of claim 15, wherein the one or more statistical models include at least one of the following: regression analysis; cluster analysis/spread spectrum analysis; Bayesian Probability Analysis (Acyclic); Markov Networks; Relevance Analysis; Heuristic Modeling/Meteheuristic; Simulated Annealing; Genetic Algorithms;
Statistical Analysis; Support Vectors, Monte Carlo Simulators; and combinations thereof.

20. The machine-learning system of claim 15, wherein the data input is provided to a virtual machine for further analysis in the event that the data input is identified as statistically anomalous.
